(19) United States
(12) Patent Application Publication
(10) Pub. No.: US 2026/0345417 A1
(43) Pub. Date: Nov. 5, 2026

(54) LIP STRETCHING DEVICE

(71) Applicants: Robert Walter Christensen, III, Denver, CO (US); Dominic Snyder, Denver, CO (US)

(72) Inventors: Robert Walter Christensen, III, Denver, CO (US); Dominic Snyder, Denver, CO (US)

(21) Appl. No.: 19/666,023

(22) Filed: May 1, 2026

Related U.S. Application Data
(60) Provisional application No. 63/799,030, filed on May 2, 2025.

(51) Int. Cl. A61H 1/02

(52) U.S. Cl. CPC A61H 1/0218; A61H 2001/0233; A61H 2201/1664; A61H 2201/169

(57) ABSTRACT

A lip stretching device includes a spring connected to a first arm and a second arm. The first and second arms have a bend at the top of their length above the spring extending out to a mouthpiece. The mouthpiece has a labial bed with an intra-oral retainer and an extra-oral retainer. The first and second arms further have an activator lever area below the spring.

### CROSS-REFERENCE TO RELATED APPLICATIONS

This application claims the benefit of U.S. Provisional Application No. 63/799,030, filed May 2, 2025, which is hereby incorporated by reference in its entirety.

### FIELD OF INVENTION

The present disclosure relates to devices for stretching and exercising facial tissue, and more particularly to a lip stretching device for the treatment and prevention of microstomia.

### BACKGROUND

Microstomia is a condition characterized by a limited oral opening. The condition may result from various causes, including thermal or chemical burns around and in the mouth, which can lead to scar tissue formation that shrinks over time and tightens the lips, thereby limiting the oral opening. Other causes of microstomia may include facial trauma and genetic developmental conditions.

Individuals suffering from microstomia may experience difficulties with everyday activities such as eating, speaking, and maintaining oral hygiene. The condition may also present challenges for dental examinations and medical procedures that require access to the oral cavity. In some cases, microstomia may progressively worsen if left untreated, as scar tissue continues to contract and further restrict the oral opening.

Various approaches have been proposed for treating and preventing microstomia. Some devices provide lateral stretching to the facial tissue using straight members that slide past each other in opposite directions. Other devices apply force to the mouth via members connected by hinges. Devices for rehabilitating temporomandibular joint disorders also exist, though these tend to be designed to accommodate the teeth rather than the lips. Additionally, apparatuses for propping the mouth open during dental examinations and procedures have been presented.

Stretching therapy for the treatment and prevention of microstomia may take different forms, including manual stretching, dynamic stretching that provides continual force on tissues, and static stretching that holds tissues at a fixed position. Different patients may benefit from different types of stretching therapy depending on the severity of their condition and their stage of treatment.

Therefore, improved devices and methods for stretching and exercising facial tissue may be desirable.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a lip stretching device is provided. The lip stretching device includes a spring connected to a first arm and a second arm. The first and second arms have a bend at the top of their length above the spring extending out to a mouthpiece. The mouthpiece has a labial bed with an intra-oral retainer and an extra-oral retainer. The first and second arms further have an activator lever area below the spring.

According to other aspects of the present disclosure, the lip stretching device may include one or more of the following features. The lip stretching device may further include at least one of an elastic band and a hook-and-loop band, the bands wrapped around the activator area. The arms may have at least one finger area. The spring may be elastic. The spring may comprise a serpentine spring. The bend of the arms may be between 45 and 90 degrees. The lip stretching device may be one piece. The mouthpiece may be silicone. In some aspects, the mouthpiece 130 is overmolded onto the first arm 102, and the second mouthpiece 130′ is overmolded onto the second arm 102′. The mouthpiece may be between 5 mm and 40 mm tall.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 illustrates an isometric view of a lip stretching device, according to aspects of the present disclosure.

FIG. 2A illustrates a view of the lip stretching device of FIG. 1 in use, according to aspects of the present disclosure.

FIG. 2B illustrates another view of the lip stretching device of FIG. 1 in use, according to aspects of the present disclosure.

FIG. 3A illustrates a view of the lip stretching device with an elastic band, according to aspects of the present disclosure.

FIG. 3B illustrates a view of the lip stretching device with a hook-and-loop strap, according to aspects of the present disclosure.

FIG. 4 illustrates an isometric view of an alternative embodiment of the lip stretching device, according to aspects of the present disclosure.

FIG. 5 illustrates an isometric view of a lip stretching device, according to aspects of the present disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

The present disclosure describes a lip stretching device for stretching and exercising facial tissue. The lip stretching device may be used for the treatment and prevention of microstomia, a condition characterized by a limited oral opening. In some cases, microstomia may result from thermal or chemical burns around and in the mouth, which may cause scar tissue that shrinks over time and tightens the lips, thereby limiting the oral opening. Other causes of microstomia may include facial trauma and genetic developmental conditions.

The lip stretching device described herein includes a first arm and a second arm connected by a spring. Each arm includes a mouthpiece configured to engage a portion of a user's lips. The mouthpieces may be positioned at the commissures of the user's lips to provide a lateral stretching force to the oral opening. The lip stretching device may be configured to provide multiple forms of stretching therapy, including manual stretching, dynamic stretching, and static stretching. Different patients may benefit from different types of stretching therapy depending on the severity of their condition and their stage of treatment.

The following description sets forth various aspects of the lip stretching device. The description includes structural features of the lip stretching device, operation of the lip stretching device, band configurations for stretching therapy, and alternative embodiments of the lip stretching device.

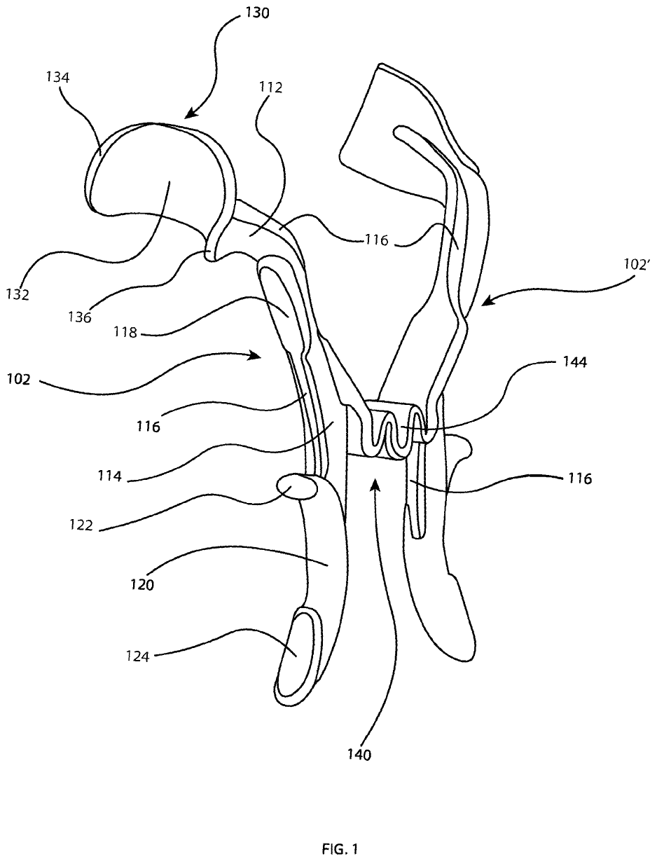

FIG. 1 illustrates an isometric view of a lip stretching device according to aspects of the present disclosure. The lip stretching device comprises a first arm 102 and a second arm 102′ connected by a spring 140. The spring 140 may be compressed with a compressive load. Each of the first arm 102 and the second arm 102′ is a shaped bar with a top and an outside face. In some aspects, the first arm 102 and the second arm 102′ are inversely oriented symmetrical bodies with corresponding features on each arm.

At the top of the first arm 102 is an angled extension 112 which bends the first arm 102 and connects to a first mouthpiece 130. In some aspects, the angled extension 112 bends the first arm 102 at an angle between 15 degrees and 90 degrees, for example 75 degrees, to connect to the first mouthpiece 130. The angled extension 112 has a curve of less than 90 degrees so that the lip stretching device outside of the mouth does not impinge on the lower face of the user. In some aspects, the bend of the arms is between 45 and 80 degrees.

Below the angled extension 112 on the outside face of the first arm 102 is a compression area 118. In the middle area of the first arm 102 is an arm torso 114. At the bottom of the first arm 102 is an activator area 120, which includes an activator retainer 122 at a first end of the activator area 120 and a lower finger hold 124 at a second end of the activator area 120. In some aspects, the activator area 120 may comprise a band engagement feature configured to receive a band for maintaining the first mouthpiece and the second mouthpiece in a separated position. The activator area 120 may have a curved shape. The curved portion between the activator retainer 122 and the lower finger hold 124 may be in the range of 5 mm to 60 mm. In some aspects, the first arm 102 may have a total length in the range of 40 mm to 120 mm, measured from the curve of the angled extension 112 to the bottom of the lower finger hold 124.

In various embodiments, the first and second arms 102, 102′ are curved and arranged to curve in towards each other, such that the ends of each arm are spaced further apart from each other than the respective arm torsos.

In various embodiments, each of the first arm 102 and the second arm 102′ may comprise a rib 116 positioned along an inside-facing surface of the body of the respective arm. The rib 116 may be positioned below the spring 140. The rib 116 may provide support along the length of the respective arm, which strengthens the respective arm 102 and may prevent the arms 102, 102′ from bending or twisting while under pressure.

The first mouthpiece 130 extends from the angled extension 112 at the top of the first arm 102. The first mouthpiece 130 includes a curved labial bed 132 with a posterior side and an anterior side. The labial bed 132 is curved convexly to the outside face of the first arm 102. In some aspects, the face of the labial bed 132 has a height in a range of 5 mm to 40 mm and a width in a range of 10 mm to 50 mm. Along the posterior side of the labial bed 132 is an intra-oral ridge 134 which extends upwards in a curve from the labial bed 132. In some aspects, the intra-oral ridge 134 extends upwards from 1 mm to 30 mm in a curve from the labial bed 132. Along the anterior side of the labial bed 132 is an extra-oral ridge 136. In some aspects, the extra-oral ridge 136 extends from 1 mm to 20 mm from the labial bed 132.

In various embodiments, the spring 140 connects the first arm 102 to the second arm 102′ and is positioned at a central region of each arm. In particular, in various embodiments, the spring 140 connects to the inside faces of the first arm 102 and the second arm 102′ at their respective arm torso 114 sections. In some aspects, the spring 140 is a flat bar formed into a serpentine spring. The spring 140 allows the first arm 102 and the second arm 102′ to move in relation to each other. The serpentine spring encourages the material to bend and compress along the axis of the first arm 102, and the serpentine shape of the spring 140 also inhibits the bending of the material perpendicular to that axis, so that the material of the lip stretching device generally bends to compress the first arm 102 and the second arm 102′ in plane toward each other. Furthermore, when the material of the spring 140 bends, regions of the serpentine spring move one side toward the other regions of the serpentine spring and the opposite side away from the opposing serpentine regions, until the serpentine regions contact each other, which prevent the spring 140 from over-compressing and damaging the device. In some aspects, the spring 140 is elastic such that the first arm 102 and the second arm 102′ can be compressed together from their initial state.

In some aspects, the first arm 102, the second arm 102′, and the spring 140 are made of a single unitary piece of material. In various embodiments, the first arm 102, the second arm 102′, and the spring 140 are formed of a plastic material, a metal material, or a combination thereof. In some aspects, the lip stretching device may be made of a combination of separate, distinct components. For example, the mouthpiece 130, the spring 140, the first arm 102, and the second arm 102′ may be formed as separate components and coupled together using fasteners, adhesive, or other suitable bonding material or bonding methods.

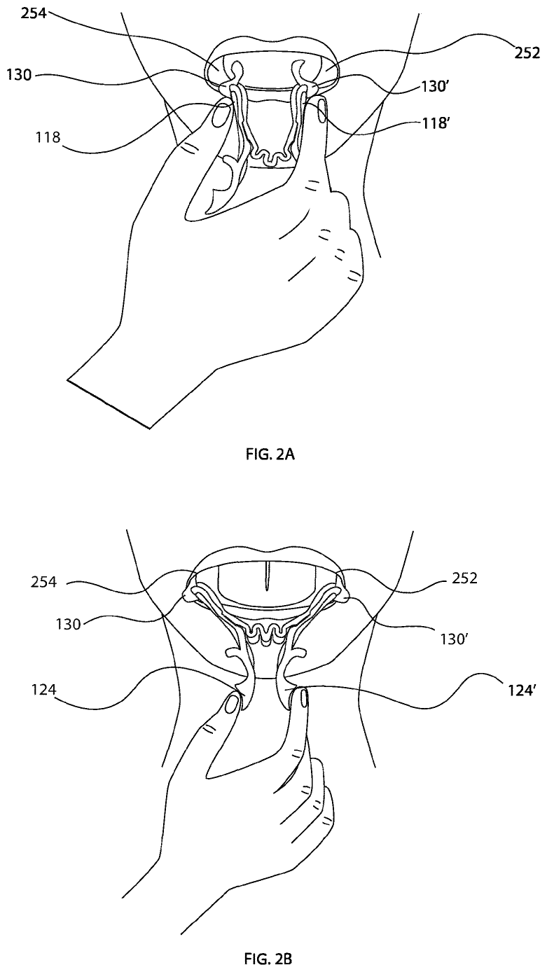

FIGS. 2A-2B illustrate views of the lip stretching device in use. In FIGS. 2A-2B, the lip stretching device is positioned in a user's mouth between a left mouth corner 252 and a right mouth corner 254. A second mouthpiece 130′ is positioned at an upper end of the second arm 102′ opposite the first mouthpiece 130. The first mouthpiece 130 and the second mouthpiece 130′ of the lip stretching device contact the right and left commissure corners of the user's lips. The lip stretching device may be positioned at the commissures, the side corners, of the lips to stretch the lips and mouth horizontally. In some aspects, the lip stretching device may be applied in any direction or in multiples to a user's lips.

The curve of the angled extension 112 is shaped so that when the first arm 102 and the second arm 102′ are compressed together with the spring 140, the first mouthpiece 130 and the second mouthpiece 130′ primarily move horizontally to and from each other without rotating. The horizontal motion prevents the intra-oral ridge 134 or the extra-oral ridge 136 from turning into the flesh of the user during operation.

In FIG. 2A, the user squeezes the lip stretching device at a compression area 118 on the first arm 102 and a compression area 118′ on the second arm 102′ to move the first mouthpiece 130 and the second mouthpiece 130′ closer together. When the first mouthpiece 130 and the second mouthpiece 130′ are pushed together, the lip stretching device may be inserted into an oral opening in a range of 2 mm to 100 mm from side-to-side. The intra-oral ridge 134 along the labial bed 132 helps prevent the lip stretching device from falling out of the mouth during use. The extra-oral ridge 136 helps prevent the lip stretching device from falling into the user's mouth.

In FIG. 2B, the user holds or squeezes the lip stretching device at a lower finger hold 124 on the first arm 102 and a lower finger hold 124′ on the second arm 102′ to move the first mouthpiece 130 and the second mouthpiece 130′ further apart for stretching. When the tops of the first arm 102 and the second arm 102′ are rotated away from each other, the first mouthpiece 130 and the second mouthpiece 130′ rotate away from each other until the activator area 120 and the activator area 120′ contact each other. In some aspects, the distance between the activator area 120 of the first arm 102 and the activator area 120′ of the second arm 102′ is 20 mm 80 mm, and 0 mm when fully open In other words, the respective activator areas may make direct contact with each other. In some aspects, the lip stretching device provides therapy for oral openings as small as 10 mm wide with a maximum horizontal distance of 90 mm across.

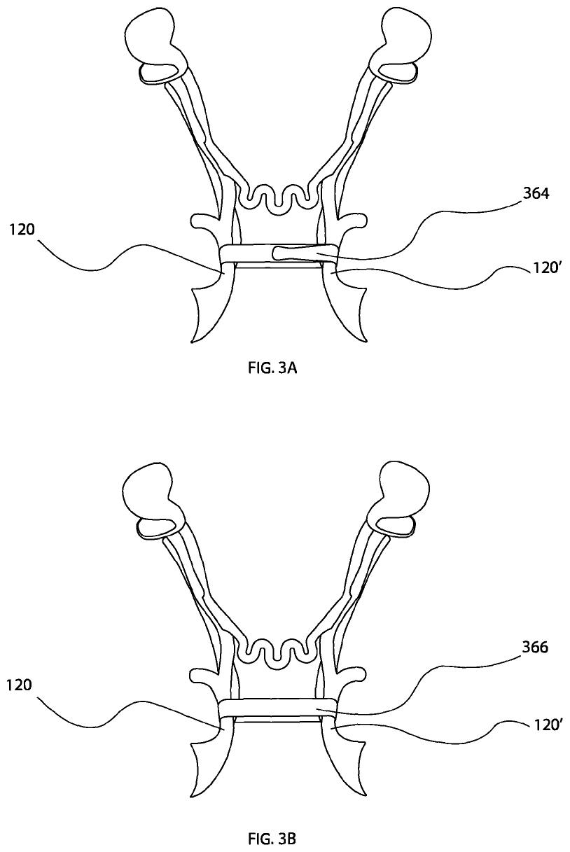

FIGS. 3A-3B illustrate views of the lip stretching device with band configurations for stretching therapy. The lip stretching device may be used with multiple forms of stretching therapy, including manual stretching, dynamic stretching, and static stretching.

FIG. 3A illustrates the lip stretching device with a hook-and-loop strap 364 wrapped around the activator area 120 of the first arm 102 and the activator area 120′ of the second arm 102′. In some aspects, the hook-and-loop strap 364 has a length in a range of 20 mm to 100 mm and a width in a range of 2 mm to 25 mm, with hook fabric on one side and loop fabric on the other side. The hook-and-loop strap 364 may be wrapped around the activator area 120 and the activator area 120′, and the hook-and-loop strap 364 may be adhered to itself to hold the lip stretching device in a static position for static stretching.

FIG. 3B illustrates the lip stretching device with an elastic band 366 wrapped around the activator area 120 of the first arm 102 and the activator area 120′ of the second arm 102′. In some aspects, the elastic band 366 is made of silicone. In some aspects, the elastic band 366 may be made of any elastic material that will stretch and hold the lip stretching device.

To provide manual stretching, the user presses against the lower finger hold 124 of the first arm 102 and the lower finger hold 124′ of the second arm 102′, which moves the first mouthpiece 130 and the second mouthpiece 130′ away from each other to stretch the user's lips and mouth.

To provide dynamic stretching, the properties of the device materials are elastic such that the spring 140 provides compression and tension when the first arm 102 and the second arm 102′ are compressed or extended from their initial state. The spring 140 provides a dynamic mechanical force that presses the first mouthpiece 130 and the second mouthpiece 130′ apart from each other at smaller widths. To press the first mouthpiece 130 and the second mouthpiece 130′ apart further or with greater force, one or more elastic bands 366 may be added to the activator area 120 and the activator area 120′. Based on the properties of the elastic band 366, the lip stretching device may provide a dynamic force to the lips with continual pressure.

To provide static stretching, the user wraps the hook-and-loop strap 364 around the activator area 120 of the first arm 102, then loops the hook-and-loop strap 364 around the activator area 120′ of the second arm 102′, squeezing the activator area 120 and the activator area 120′ to a desired distance and then adhering the hook-and-loop strap 364 to itself to hold the lip stretching device in a static position holding the lips for a desired stretch.

In some aspects, if the lip stretching device is opening too wide, the hook-and-loop strap 364 may be wrapped around the compression area 118 of the first arm 102 and the compression area 118′ of the second arm 102′ to limit the distance between the first mouthpiece 130 and the second mouthpiece 130′. In some aspects, if the lip stretching device is opening with too much force from the spring 140, the elastic band 366 may be wrapped around the compression area 118 of the first arm 102 and the compression area 118′ of the second arm 102′ to limit the pressure applied from the lip stretching device to the user.

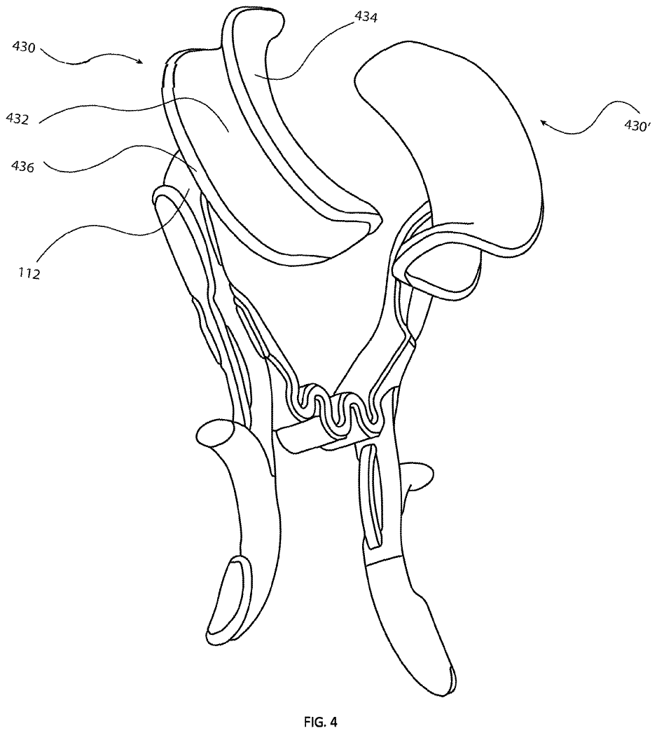

FIG. 4 illustrates an isometric view of an alternative embodiment of the lip stretching device featuring a broad mouthpiece 430 and a second broad mouthpiece 430′. The broad mouthpiece 430 extends from the angled extension 112 of the first arm 102, and the second broad mouthpiece 430′ extends from the angled extension 112 of the second arm 102′.

The broad mouthpiece 430 includes a broad labial bed 432 with a broad intra-oral ridge 434 on one side and a broad extra-oral ridge 436 on an opposite side. In some aspects, the broad labial bed 432 curves from 10 mm to 60 mm from top to bottom with a width of between 5 mm to 30 mm. The elongated curved shape of the broad mouthpiece 430 spreads pressure over a larger area of the user's lips compared to the first mouthpiece 130 of the first embodiment. The broad intra-oral ridge 434 helps prevent the lip stretching device from falling out the user's mouth, while the broad extra-oral ridge 436 helps retain the lip stretching device in position by preventing the lip stretching device from slipping into the user's mouth. The second broad mouthpiece 430′ may be configured as a mirror image of the broad mouthpiece 430.

In some aspects, the broad mouthpiece 430 and the second broad mouthpiece 430′ are made of silicone. In some aspects, the broad mouthpiece 430 is overmolded onto the first arm 102, and the second broad mouthpiece 430′ is overmolded onto the second arm 102′.

In some aspects, the lip stretching device may include smaller mouthpieces for users with severe microstomia having very small oral openings or for infants. In some aspects, foam pads or silicone pads may be added to the mouthpieces to provide additional cushioning. In some aspects, the spring 140 may be configured to open wider to accommodate larger oral openings. In some aspects, the first arm 102 and the second arm 102′ may be longer to allow the mouthpieces to open wider or shorter to open less wide. In some aspects, the mouthpieces may be shaped to close together to an even smaller distance to accommodate users with smaller oral openings.

The lip stretching device operates through the coordinated interaction of the first arm 102, the second arm 102′, the spring 140, the mouthpieces, and the activator areas 120, 120′ to provide stretching therapy to a user's lips.

As illustrated in FIG. 1 and FIGS. 2A-2B, the spring 140 connects the first arm 102 and the second arm 102′ at the respective arm torso 114 sections (i.e., central region). The spring 140 permits the first arm 102 and the second arm 102′ to move relative to each other. When the upper portions of the first arm 102 and the second arm 102′ move toward each other, the first mouthpiece 130 and the second mouthpiece 130′ move closer together. When the upper portions of the first arm 102 and the second arm 102′ move away from each other, the first mouthpiece 130 and the second mouthpiece 130′ move further apart. The serpentine shape of the spring 140 allows the arms to move towards and away from each other in a common plane and prevents rotation of the arms outside the common plane. The serpentine shape may also function as a barrier to prevent over-compression by contacting each other when the spring 140 reaches a compression limit.

The angled extension 112 at the top of each arm positions the first mouthpiece 130 and the second mouthpiece 130′ at an angle relative to the body of the respective arm. The curve of the angled extension 112 may be shaped so that when the first arm 102 and the second arm 102′ move according to the spring 140, the first mouthpiece 130 and the second mouthpiece 130′ move primarily horizontally toward and away from each other without rotating. The horizontal motion may prevent the intra-oral ridge 134 or the extra-oral ridge 136 from turning into the flesh of the user during operation.

As shown in FIGS. 2A-2B, the compression area 118 and the compression area 118′ provide leverage points for manual operation of the lip stretching device. When a user squeezes the compression area 118 and the compression area 118′ together, the first mouthpiece 130 and the second mouthpiece 130′ move closer together, which may facilitate insertion of the lip stretching device into the user's mouth. The lower finger hold 124 and the lower finger hold 124′ provide leverage points at the bottom of the activator area 120 and the activator area 120′. When a user presses the lower finger hold 124 and the lower finger hold 124′ together, the first mouthpiece 130 and the second mouthpiece 130′ move further apart to provide a stretching force to the left mouth corner 252 and the right mouth corner 254.

As illustrated in FIGS. 3A-3B, the activator area 120 and the activator area 120′ provide attachment points for bands used in stretching therapy. The activator retainer 122 on each activator area may engage a band to secure the band in position. The hook-and-loop strap 364 may be wrapped around the activator area 120 and the activator area 120′ to hold the first arm 102 and the second arm 102′ in a position that maintains the first mouthpiece 130 and the second mouthpiece 130′ in a separated configuration for static stretching. The elastic band 366 may be wrapped around the activator area 120 and the activator area 120′ to provide a dynamic means for compressing the activator areas toward one another.

The labial bed 132, the intra-oral ridge 134, and the extra-oral ridge 136 of each mouthpiece work together to retain the lip stretching device in position during use while distributing pressure across the lip tissue. The intra-oral ridge 134 receives a portion of the user's lip and provides a surface against which the lip tissue rests during stretching. The labial bed 132 extends from the intra-oral ridge 134 on the posterior side and may help prevent the lip stretching device from falling out of the mouth during use. The extra-oral ridge 136 extends from the labial bed 132 on the anterior side and may help prevent the lip stretching device from falling into the user's mouth. The curved shape of the labial bed 132 and the intra-oral ridge 134 may distribute pressure over the lip tissue to reduce localized pressure points during stretching therapy.

As illustrated in FIG. 4, the broad mouthpiece 430 and the second broad mouthpiece 430′ provide an alternative configuration for distributing force across the user's lips. The broad labial bed 432, the broad intra-oral ridge 434, and the broad extra-oral ridge 436 function in a manner similar to the intra-oral ridge 134, the intra-oral ridge 132, and the extra-oral ridge 136, respectively. The elongated curved shape of the broad mouthpiece 430 and the second broad mouthpiece 430′ may spread pressure over a larger area of the user's lips compared to the first mouthpiece 130 and the second mouthpiece 130′.

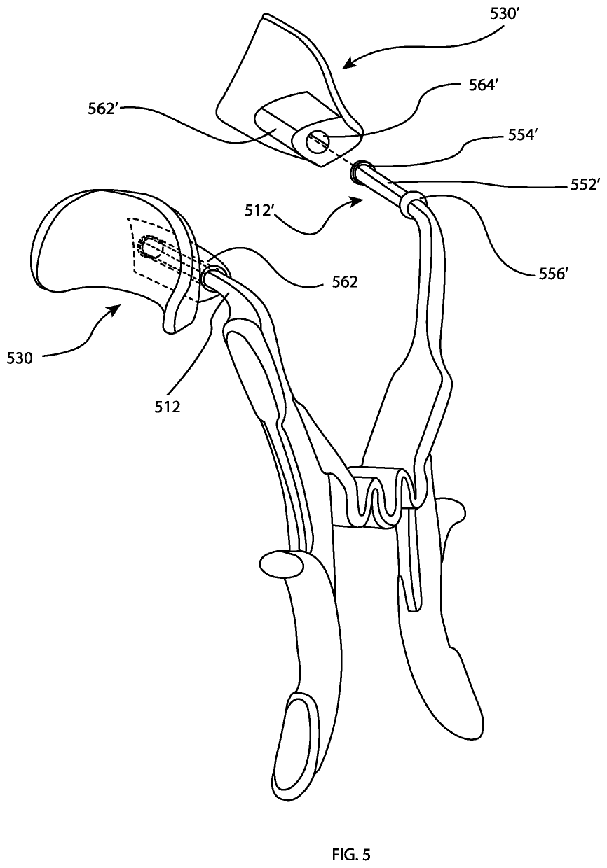

In various embodiments, and referring to FIG. 5, the lip stretching device may comprise a detachable mouthpiece 530 that includes an arm interface 562 that extends off the back of the mouthpiece 530 and which connects to an angled connector 512 on the first arm. In addition, the lip stretching device may comprise a second detachable mouthpiece 530′ that includes a second arm interface 562′ which is detached from a second angled connector 512′ on the second arm of the lip stretching device.

In the present embodiment, the angle connector 512 and second angled connector 512′ may comprise a cylindrically shaped rotational shaft 552′ having a diameter. The arm interface 562′ and second arm interface 562′ may further comprise a cylindrical void 564′ which is slightly shorter than the length of, and slightly larger than the diameter of the rotational shaft 552′. The angled connector 512′ may further comprise an anterior retainer 556′ sized larger than the cylindrical void 564′ and a posterior retainer 554′ that is sized or shaped slightly larger than the diameter of the cylindrical void 564′.

As shown in FIG. 5, the detachable mouthpieces 530 and 530′ may be attached to the lip stretching device by sliding the angled connector 512 through the arm interface 562, which now surrounds the rotational shaft 552′ and is held in between the posterior retainer 554′ and the anterior retainer 556'. In some embodiments, the posterior retainer 554′ could be an overmolded soft plastic that compresses when the angled connector 512 is inserted through the arm interface. In other embodiments, the posterior retainer 554′ could be a ring, a clip, or other component that is attached to the angled connector 512 after it is inserted.

In the present embodiment, the cylindrical shapes of the angled connector 512 and the arm interface 562 allow the detachable mouthpieces to rotate and thus stay in position against the commissure of the mouth without turning with the motion of the first arm 102 and second arm 102′.

In some embodiments, the angled connector 512 and arm interface 562 could be other shapes or have additional components that allow limited or no rotation between them. Further embodiments could also have alternative attachment structures between the detachable mouthpiece 530 and the arms of the lip stretching device, including but not limited to structures for a clip, a snap-fit, a ball and socket joint, a latch, or a press fit system, or combinations thereof. In some embodiments, the shape of the two detachable mouthpieces could be different from each other. Some embodiments may further comprise additional mouthpieces of various sizes and shapes to form a kit for individual customization.

A number of implementations have been described. Nevertheless, it will be understood that various modifications may be made without departing from the spirit and scope of the disclosure. Accordingly, other implementations are within the scope of the following claims.

The preceding detailed description is merely illustrative in nature and is not intended to limit the embodiments of the subject matter or the application and uses of such embodiments.

As used herein, the words “various” and “exemplary” means “serving as an example, instance, or illustration.” Any implementation described herein as various or exemplary is not necessarily to be construed as preferred or advantageous over other implementations. Furthermore, there is no intention to be bound by any expressed or implied theory presented in the preceding technical field, background, or detailed description.

Any connecting lines shown in the various figures contained herein are intended to represent exemplary functional relationships and/or physical couplings between the various elements. It should be noted that many alternative or additional functional relationships or physical connections may be present in an embodiment of the subject matter. In addition, certain terminology may also be used herein for the purpose of reference only, and thus are not intended to be limiting, and the terms “first”, “second” and other such numerical terms referring to structures do not imply a sequence or order unless clearly indicated by the context.

The foregoing description refers to elements or features being “connected” or “coupled” together. As used herein, “connected” and “coupled” are used interchangeably. As used herein, unless expressly stated otherwise, “connected” and “coupled” means that one element is directly or indirectly joined to (or directly or indirectly communicates with, electrically or otherwise) another element, and not necessarily mechanically.

While at least one exemplary embodiment has been presented in the foregoing detailed description, it should be appreciated that a vast number of variations exist. It should also be appreciated that the exemplary embodiment or various embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

1. A lip stretching device, comprising:
a first arm and a second arm, each arm having an upper portion and a lower portion;
a spring connecting the first arm and the second arm at a location between the upper portion and the lower portion of each arm;
an angled extension at the upper portion of each arm, the angled extension bending outward from the arm at an angle between 45 and 80 degrees;
a first mouthpiece connected to the angled extension of the first arm and a second mouthpiece connected to the angled extension of the second arm, each mouthpiece comprising:
a labial bed configured to receive a portion of a user's lip;
an intra-oral ridge extending from the labial bed on a posterior side; and
an extra-oral ridge extending from the labial bed on an anterior side; and
an activator area at the lower portion of each arm below the spring, the activator area including an activator retainer configured to engage a band.

2. The lip stretching device of claim 1, further comprising a fastener wrapped around the activator area of the first arm and the activator area of the second arm.

3. The lip stretching device of claim 1, wherein each arm further comprises a compression area positioned on an outside face of the arm below the angled extension.

4. The lip stretching device of claim 3, wherein each arm further comprises a lower finger hold positioned at a bottom of the activator area.

5. The lip stretching device of claim 4, wherein the first arm and the second arm are curved in toward each other.

6. The lip stretching device of claim 1, wherein the lip stretching device is formed as a single unitary piece.

7. The lip stretching device of claim 1, wherein the first mouthpiece and the second mouthpiece comprise silicone.

8. The lip stretching device of claim 1, wherein each mouthpiece has a height between 5 mm and 40 mm.

9. The lip stretching device of claim 1, wherein the first mouthpiece is detachable from the and the second mouthpiece is detachable from the.

10. The lip stretching device of claim 1, wherein each arm further comprises a rib positioned along a body of the arm and below the spring.

11. The lip stretching device of claim 1, wherein the spring comprises a serpentine spring comprising a first end connected to the first arm and a second end connected to the second arm.

12. A lip stretching device, comprising:
a first arm and a second arm connected by a spring, the spring positioned at a central region of each arm;
a first mouthpiece at an upper end of the first arm and a second mouthpiece at an upper end of the second arm, each mouthpiece comprising:
a labial bed;
an intra-oral ridge on a first side of the labial bed; and
an extra-oral ridge on a second side of the labial bed opposite the first side;
an activator area at a lower end of each arm below the spring; and
a band engagement feature on each activator area configured to receive a band for maintaining the first mouthpiece and the second mouthpiece in a separated position.

13. The lip stretching device of claim 12, wherein the spring comprises a serpentine spring.

14. The lip stretching device of claim 12, wherein each arm comprises an angled extension connecting the arm to the respective mouthpiece.

15. The lip stretching device of claim 12, further comprising an elastic band wrapped around the activator area of the first arm and the activator area of the second arm.

16. The lip stretching device of claim 12, further comprising a hook-and-loop strap wrapped around the activator area of the first arm and the activator area of the second arm.

17. The lip stretching device of claim 12, wherein each arm comprises a compression area and a lower finger hold.

18. A lip stretching device, comprising:
a first arm and a second arm;
a spring connecting the first arm and the second arm;
a mouthpiece at an upper end of each arm, each mouthpiece having a labial bed; and
an activator area at a lower end of each arm

19. The lip stretching device of claim 18, wherein the mouthpiece comprises a broad mouthpiece having an elongated curved shape.

20. The lip stretching device of claim 18, wherein the spring comprises a serpentine spring configured to permit the first arm and the second arm to move toward each other along a common plane.
